(19) United States
(12) Patent Application Publication
(10) Pub. No.: US 2006/0286893 A1
(43) Pub. Date: Dec. 21, 2006

(54) Child entertainment and learning device for use with a high chair tray

(76) Inventor: Jonathan W. Conaway, Hamilton, OH (US)

Correspondence Address: TAFT, STETTINIUS & HOLLISTER LLP, SUITE 1800, 425 WALNUT STREET, CINCINNATI, OH, 45202-3957, US

(21) Appl. No.: 11/026,333

(22) Filed: Dec. 30, 2004

(51) Int. Cl. A63H 33/00; G09B 5/00

(52) U.S. Cl. 446/227; 434/307 R

(57) ABSTRACT

A child entertainment and learning device may comprise a tray-shaped insert having interactive buttons placed thereon for use by a child. Program selection buttons may be provided and may be in the shape of letters, numbers, shapes, animals, musical instruments, etc. to allow a user thereof to select a desired program. A speaker may be provided for use to provide audible prompts to a user thereof. A user response button may be provided for use in responding to said prompts as set forth by a selected program. The user response button may be opaque or transparent and may include lights visible in or below the button for displaying a desired indicia correlating with the selected program. The programs and speaker may be controlled by electronic control circuit. Connectors may be provided to releasably secure the child entertainment and learning device to trays of different sizes or shapes or other flat surfaces.

### BACKGROUND OF THE INVENTION

The present invention relates to an entertainment and learning device for children, and more specifically to a child entertainment and learning device that may be removably received by a high chair tray or other flat surface.

Known in the prior art are electronic child entertainment and education apparatuses adapted for use by young children. Also known are child entertainment devices that can facilitate learning of various matters including shapes, numbers, letters, etc. What is desired is a child entertainment and learning device specifically adapted for use with high chair trays of various sizes and shapes or other flat surfaces.

### SUMMARY OF THE INVENTION

Embodiments of the invention are directed to a child entertainment and learning device specifically adapted for use with a high chair tray.

In an embodiment, the child entertainment and learning device may comprise a tray-shaped insert having interactive buttons placed thereon for use by a child. Program selection buttons may be provided and may be in the shape of letters, numbers, shapes, animals, musical instruments, etc. to allow a user thereof to select a desired program. A speaker may be provided to provide audible prompts to a user thereof. A user response button may be provided for use in responding to said prompts as set forth by a selected program. The user response button may be opaque or transparent and may include lights visible in or below the button for displaying a desired indicia correlating with the selected program. The programs and speaker may be controlled by an electronic control circuit.

In an embodiment, the child entertainment and learning device may be in the shape of an insert that is specifically shaped to be received within the outer boundaries of a specific tray for a child's high chair. The device may include a handle thereon for easier manipulation by a user. The device may include an on/off switch that has at least two volume control positions for turning the electronic control circuit on and off and for controlling the audible volume of the speaker. The device may include a battery cover that may be held on with a fastener and which covers batteries for providing DC power to the electronic control circuit.

In an embodiment, the child entertainment and learning device includes connectors for adapting the device to be removably attached to child high chair trays of varying shapes and designs. Preferably, the child entertainment and learning device may include slots on a bottom thereof for receiving the connectors. The connectors may include suction cups for releasably attaching the connectors to a child's high chair tray or other flat surfaces. The stalks are preferably of sufficient length to space the child entertainment and learning device above the rim of a high chair tray, and grooves are preferably located on the stalks and are shaped to be slidably received by the slots on the bottom of the device.

These and other embodiments of the invention are described in further detail below with reference to the following detailed description and drawings.

### BRIEF DESCRIPTION OF THE DRAWINGS

FIG. 1 is a top perspective view of a child entertainment and learning device according to one exemplary embodiment of the present invention;

FIG. 2 is a bottom perspective view of the child entertainment and learning device shown in FIG. 1:

FIG. 3 is a bottom perspective view of the child entertainment and learning device shown in FIG. 2 showing connectors for use in connection therewith; and

FIG. 4 is a close-up side perspective view of a connector as shown in FIG. 3.

### DETAILED DESCRIPTION

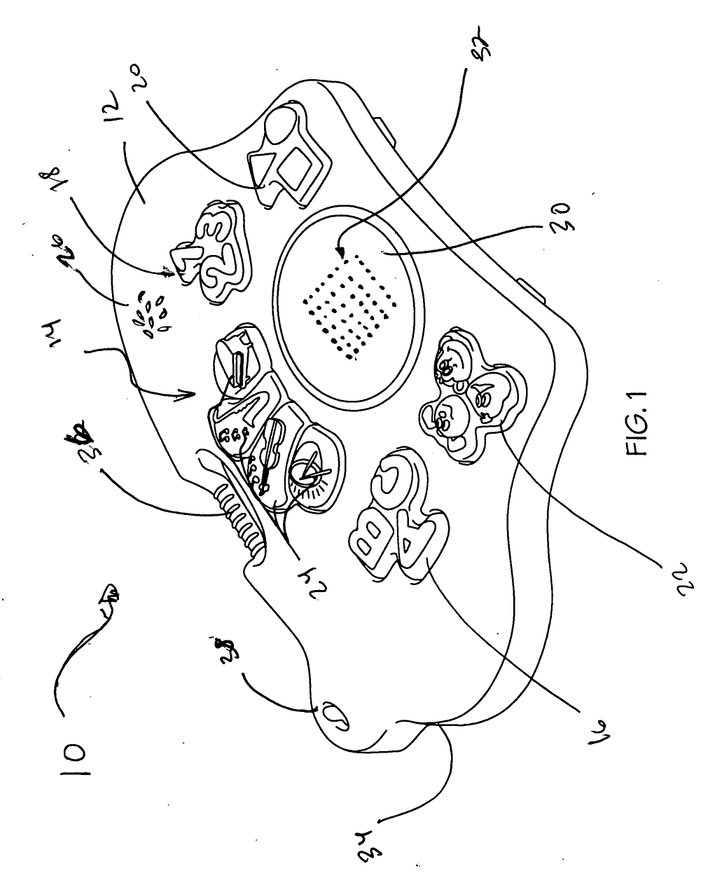

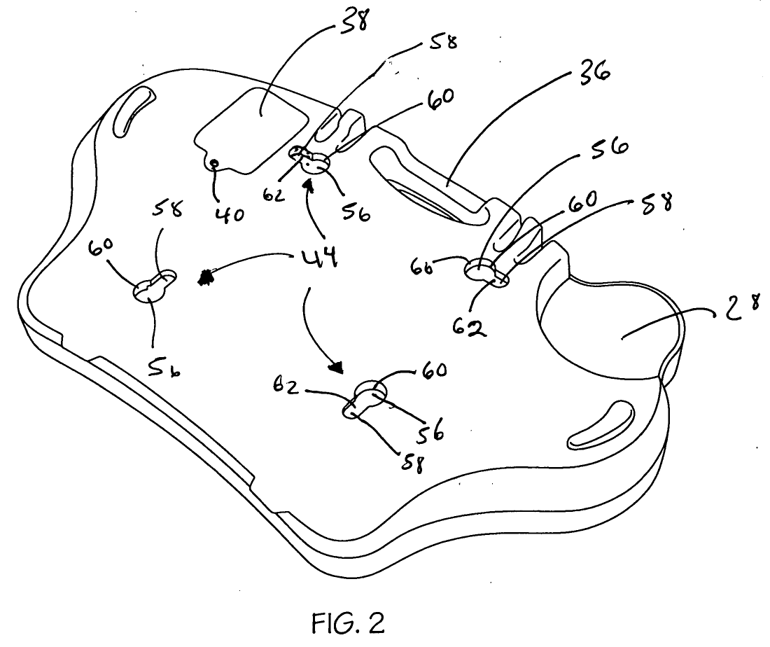

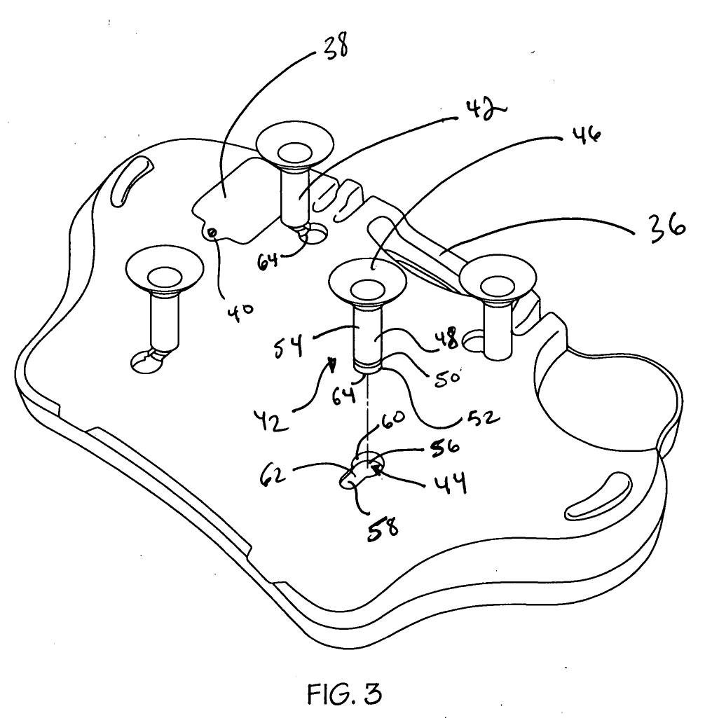

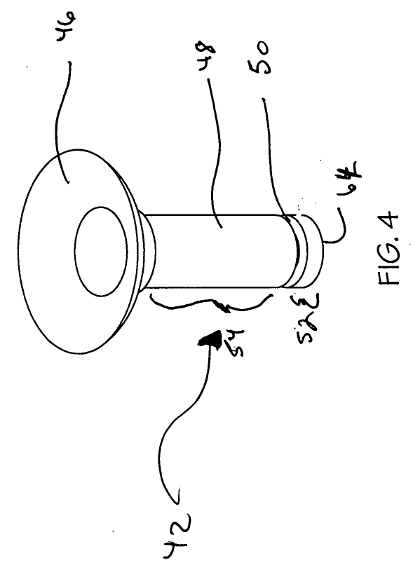

In an embodiment, and as shown in FIGS. 1-4, the child entertainment and learning device 10 may comprise a tray-shaped insert 12 having interactive buttons placed thereon for use by a child. Program selection buttons 14 may be provided and may be in the shape of letters 16, numbers 18, shapes 20, animals 22, musical instruments 24, etc. to allow a user thereof to select a desired program. A speaker 26 may be provided to provide audible prompts to a user thereof. A user response button 30 may be provided for use in responding to said prompts as set forth by a selected program. The user response button 30 may be shaped and sized for easy manipulation by a child. The user response button may be opaque or transparent and may include lights 32 visible in or below the button 30 for displaying a desired indicia correlating with the selected program. The programs and speaker 26 may be controlled by an electronic control circuit.

In an embodiment, the child entertainment and learning device may be mounted in a case 34 in the shape of an insert 12 that is specifically shaped to be received within the outer boundaries of a specific tray for a child's high chair. In such an embodiment, the bottom of the case 34 may include a cutout 28 specifically shaped to fit over a cupholder on a child's high chair tray. The device 10 may include a handle 36 thereon for easier manipulation by a user. The device 10 may include an on/off switch 38 that has volume control positions for turning the electronic control circuit on and off and for controlling the audible volume of the speaker 26. The device may include a battery cover 38 that may be held on with a fastener 40 and which covers batteries for providing DC power to the electronic control circuit.

The child entertainment and learning device 10 may have any suitable dimensions but is preferably in the shape of a child's high chair tray insert. Suitable materials for use in the device 10 include plastics, metals, etc. In an embodiment, the child entertainment and learning device 10 includes connectors 42 for adapting the device 10 to be removably attached to child high chair trays of varying shapes and designs. The device 10 may include slots 44 on the bottom of the case 34 for receiving the connectors 42. The connectors 42 may comprise suction cups 46 for releasably attaching the connectors 42 to a child's high chair tray, stalks 48 for spacing the device 10 above the rim of the tray, and grooves 50 located on the stalks 48 shaped to be slidably received by the slots 44 on the bottom of the device 10. More specifically, the connectors 42 may be comprised of a suction cup section 46, preferably made of rubber or another elastic or pliable material, and a stalk section 48, preferably made of plastic, or another rigid material. The stalk section 48 preferably includes a groove 50 formed in an upper end thereof forming a head 52 and a base section 54 of the stalk 48. The groove 50 is preferably shaped and sized to be received by slots 44 positioned on the bottom of the device case 34. The slots 44 preferably include a wide section 56 for releasably receiving the head 52 of the stalk 48 and a narrow section 58 for securingly receiving the head 52 of the stalk 48. The groove 50 in the stalk 48 is preferably sized slightly broader than the width of the casing material such that the bottom wall of the case 34 is captured and secured in the stalk groove 50 when the stalk head 52 is inserted in the wide section 56 of the slot 44 and slid over to the narrow section 58 of the slot 44. Preferably, the floors 62 of the slots 44 are shaped such that the case of the device 10 is supported by the tops 64 of the stalk heads 52 when the case 34 is turned right-side up and secured to a flat surface. Support for the weight of the device 10 is increased by using the tops 64 of the stalk heads 52 to support the device 10 rather than just the grooves 50. The connectors 42 may be used to releasably secure the child entertainment and learning device 10 to a flat surface, such as a table or high chair tray in the following manner. First, a plurality of the connectors 42 (preferably more than three) may be inserted, head end first, into the slots 44 on the device 10. Next, the connectors 42 may be slid from the wide portion 56 of the slots 44 to the narrow portions 58 of the slots 44, thereby catching a portion of the case 34 bottom wall 60 in the grooves 50 in the connectors 42. Finally, the device 10 may be turned over and positioned in the desired location on the flat surface prior to pressing down on the device to allow the suction cups 46 to “grab” the flat surface thereby securing the child entertainment and learning device 10 in ad desired position for use by a child.

As discussed above, the electronic control circuit (not shown) of the child entertainment and learning device 10 may include program selection buttons 14, a user response button 30, a processor and a memory unit (not shown), lights 32, a speaker 26, and an on/off switch 38. The processor and memory unit may be operatively connected to the program selection buttons, the user response button, as well as the corresponding lights and the speaker as is well-known in the art. The program selection buttons may be preferably shaped to indicate the programs that they select. For example, the letter program selection button 16 may include letters thereon, the animal program selection button 22 may include animals thereon, the number program selection button 18 may include numbers thereon, the shape program selection button 20 may have shapes thereon, the instrument program selection buttons 24 may include instruments thereon, etc. The lights 32 are preferably arranged to display images of indicia such as animals, shapes, letters and or numbers in response to a child depressing the user response button 30. The speaker 26 may be used to present audible prompts to the child, and such prompts may be annunciated concurrently with the aforementioned indicia in order to prompt the child to actuate the user response button 30. Additionally, audible prompts may be annunciated by the speaker 26 and indicia in response to the child's actuation of the user response button 30. In this manner, numbers, letter, shapes, animals, ect., may be interactively “taught” to a child in sequence.

For example, when the program selection button corresponding to the “letters” program is depressed by the user, the image of the letter “A” may be displayed concurrently with the annunciation of that letter by a voice from the speaker 26. Then, after depression of the user response button 30 in response thereto, the image of the letter “B” may be then displayed concurrently with the annunciation of that letter. In this way, the entire alphabet may be “taught” in response to the user depressing the user response button. Similarly, animals, numbers, shapes, etc. may be “taught” to a user. For example, when the program selection button corresponding to an “animals” program is depressed by a user, the image of an animal, such as an owl, may be displayed concurrently with the annunciation of the name “owl” from the speaker 26. This sequence can continue, as one of ordinary skill in the art will appreciate, for many different animals, as well as for numbers, shapes, etc.

With respect to the electronic control unit, the processor and memory units may be configured to implement any of the plurality of sequences relating to letters, numbers, shapes, animals etc. as discussed above. With respect to the display of indicia corresponding with such sequences, a plurality of appropriate lights 32, such as LEDs, arranged in an array, such as a 7×7 square array, positioned under the user response button 30 may be used to achieve the desired effect. In response to the user response button being pressed 30, the lights 32 may be activated to form a letter, number, animal, shape etc. in accordance with the selected program. As discussed above, the processor and memory unit may be programmed to display the entire alphabet, a desired set of numbers, a desired set of animals, etc. as is known in the art.

The child entertainment and learning device 10 may also include an on/off switch 38 disposed on the case 34 of the device 10. The on/off switch 38 may be a slidable switch which may have a plurality of settings corresponding with different volume levels for the speaker 26. User response button 30 can be any response button known to one skilled in the art as suitable for responding to actuation by a child. Such response buttons are commercially available and are well known to those of ordinary skill in the art. Lights 32 can be any suitable lights that are capable of displaying a sequence of indicia (e.g., letters, numbers, animals, shapes, etc.) such as LEDs as is known in the art. Preferably the user response button 30 is comprised of an opaque or clear material that allows the LEDs to be seen therethrough.

As is known in the art, any desired electrical components may be utilized for operatively coupling the components of the electronic control circuit. Such a circuit may include a circuit board or similar device containing a memory, such as a read-only memory (ROM), which is capable of acting as a voice synthesizer and/or storing pre-recorded voice responses. The processor and memory unit may be wired to the on/off switch 38, the program selection buttons 14, the user response button 30, the speaker 26, and the lights 32 to form the electronic control circuit. The processor and memory unit may be any processor and memory unit known to one skilled in the art as suitable for facilitating operation of the child entertainment and learning device. For example, the processor and memory unit may include a combination of a microprocessor (such as an application specific integrated circuit (ASIC) microprocessor) and any desired memory device, including random access memory (RAM), read only memory (ROM) or erasable programmable memory (EPROM) integrated circuit. The processor and memory unit may be mounted in the device 10 case 34.

As is well known in the art, circuits such as those discussed above may be utilized to produce the desired programs as discussed herein. More specifically, once the on/off switch 38 has been activated, and in response to the operation of the program selection buttons 14, a signal may be transmitted via the electronic control circuit to select a desired program. Then, the signal may be processed so that a second signal is transmitted to thereby produce a voice from the speaker 26 prompting a response from a user of the device 10. Simultaneously, a signal may be sent to the lights 32 to produce indicia corresponding to the audible prompt from the speaker 26. In response to the voice and the indicia, the user response button 30 may be depressed sending a signal to the processor, which then sends a corresponding signal to the speaker 26 and lights 32, to continue on to the next indicia in the particular sequence appropriate for the selected program. In this manner, when the user response button is depressed, the child is able to associate the audible prompts from the speaker with the visual array of the LED lights in the sequence of the selected program. Of course, depending on the program selected, and the desired action of the user in response thereto, the sequence and timing of where and when signals are transmitted between all of the elements of the electronic control circuit may be altered to produce the desired result as is known in the art.

While one embodiment of the invention has been described in detail, it will be apparent to those skilled in the art that the enclosed embodiment may be modified. Therefore, the foregoing description is to be considered exemplative rather than limiting.

What is claimed is:

1. A child entertainment and learning device comprising:
a high chair insert shaped case;
an electronic control circuit disposed in said case comprising an on/off switch, at least one program selection button, a user response button, a speaker, lights, a processor, and a memory unit; wherein
said processor and memory unit are programmed to send signals to said speaker, to annunciate audible prompts, and to said lights, to display images of indicia corresponding to said audible prompts, in response to actuation of said user response button.

2. The child entertainment and learning device of claim 1 further comprising detachable connectors for releasably attaching said device to a high chair tray.

3. The child entertainment and learning device of claim 2 wherein said lights comprise an array of light emitting diodes that are disposed under a surface of said user response button.

4. The child entertainment and learning device of claim 1 wherein said program selection buttons include indicia thereon indicative of the programs that may be selected by actuation of the program selection button.

5. The child entertainment and learning device of claim 4 wherein said indicia includes shapes, numbers and letters.

6. The child entertainment and learning device of claim 1 wherein said user response button is made of an opaque or transparent material and said lights are mounted benearth said button.

7. The child entertainment and learning device of claim 2 wherein said connectors include suction cups and said high chair insert shaped case includes slots on a bottom thereof for receiving said connectors.

8. A child entertainment and learning device comprising:
a high chair insert shaped case;
an electronic control circuit disposed in said case programmed to teach a child sequences of information;
slots in said case shaped to releasably receive connectors therein;
connectors shaped to be releasably received in said slots and including suction cups thereon.

9. The child entertainment and learning device of claim 8 wherein said connectors include stalk sections having grooves therein, said grooves being shaped to receive portions of the case therein.

10. The child entertainment and learning device of claim 9 wherein said slots have wide sections shaped to releasably receive head portions of said stalks and said slots include narrow sections shaped to securedly receive said head portions of said stalks.

11. The child entertainment and learning device of claim 8 wherein said electronic control circuit comprises an on/off switch, at least one program selection button, a user response button, a speaker, lights, a processor, and a memory unit.

12. The child entertainment and learning device of claim 11 wherein said processor and memory unit are programmed to send signals to said speaker, to annunciate audible prompts, and to said lights, to display images of indicia corresponding to said audible prompts, in response to actuation of said user response button.

13. The child entertainment and learning device of claim 12 wherein said lights comprise an array of light emitting diodes that are disposed under a surface of said user response button.

14. The child entertainment and learning device of claim 12 wherein said program selection buttons include indicia thereon indicative of the programs that may be selected by actuation of the program selection button.

15. A child entertainment and learning device comprising:
a high chair insert shaped case;
an electronic control circuit disposed in said case comprising an on/off switch, at least one program selection button, a user response button, a speaker, lights, a processor, and a memory unit; wherein
said processor and memory unit are programmed to send signals to said speaker, to annunciate audible prompts, and to said lights, to display images of indicia corresponding to said audible prompts, in response to actuation of said user response button;
a plurality of connectors for releasably attaching said device to a flat surface.

16. The child entertainment and learning device of claim 15 wherein said connectors include stalk sections having grooves therein, said grooves being shaped to receive portions of the case therein.

17. The child entertainment and learning device of claim 16 wherein said slots have wide sections shaped to releasably receive head portions of said stalks and said slots include narrow sections shaped to securedly receive said head portions of said stalks.

18. The child entertainment and learning device of claim 15 wherein said processor and memory unit are programmed to send signals to said speaker, to annunciate audible prompts, and to said lights, to display images of indicia corresponding to said audible prompts, in response to actuation of said user response button.

19. The child entertainment and learning device of claim 15 wherein said program selection buttons include indicia thereon indicative of the programs that may be selected by actuation of the program selection button.

20. The child entertainment and learning device of claim 19 wherein said indicia includes shapes, numbers and letters.
